(19) United States
(12) Patent Application Publication
(10) Pub. No.: US 2026/0002867 A1
(43) Pub. Date: Jan. 1, 2026

(54) DISPOSABLE FLOW CELL FOR ELECTROPHERIC MOBILITY MEASUREMENTS

(71) Applicant: Wyatt Technology, LLC, Goleta, CA (US)

(72) Inventor: Siddharth Sood, Ventura, CA (US)

(21) Appl. No.: 19/256,701

(22) Filed: Jul. 1, 2025

Related U.S. Application Data
(60) Provisional application No. 63/666,343, filed on Jul. 1, 2024.

(51) Int. Cl. G01N 21/01

(52) U.S. Cl. CPC G01N 21/01; G01N 2021/0193

(57) ABSTRACT

A flow cell comprises a top structure, comprising: a plurality of first fittings at a first side of the top structure; a plurality of second fittings at a second side of the top structure; a plurality of channels extending from the first fittings to the second fittings; a plurality of flow-through cylindrical electrodes extending through the plurality of channels, wherein a distal end of the flow-through cylindrical electrodes is offset from a distal end of the second fittings by a predetermined distance; a bottom structure comprising: a plurality of fitting receptacles constructed and arranged to connect to the second fittings; and a fluid path that extends from one channel of the plurality of channels and one of the second fittings in communication with the one channel to another channel of the plurality of channels and another of the second fittings in communication with the other channel.

### RELATED APPLICATIONS

This application claims priority to U.S. provisional patent application No. 63/666,343 filed Jul. 1, 2024 and titled “Disposable Flow Cell for Electrophoretic Mobility Measurements,” the contents of which are incorporated by reference in their entirety.

The present application is related to U.S. Provisional Patent Application Publication No. 63/466,243, the contents of which are incorporated by reference in their entirety.

### BACKGROUND

The present disclosure relates to electrophoretic mobility, and more specifically, to a flow cell for electrophoretic mobility measurements.

### SUMMARY

In one aspect, a flow cell comprises a top structure, comprising: a plurality of first fittings at a first side of the top structure; a plurality of second fittings at a second side of the top structure; a plurality of channels extending from the first fittings to the second fittings; a plurality of flow-through cylindrical electrodes extending through the plurality of channels, wherein a distal end of the flow-through cylindrical electrodes is offset from a distal end of the second fittings by a predetermined distance; a bottom structure comprising: a plurality of fitting receptacles constructed and arranged to connect to the second fittings; and a fluid path that extends from one channel of the plurality of channels and one of the second fittings in communication with the one channel to another channel of the plurality of channels and another of the second fittings in communication with the other channel.

Additionally or alternatively, the flow cell is a disposable flow cell.

Additionally or alternatively, the flow cell further comprises a plurality of electrical connectors connected to the electrodes for providing a conductive flow path to an external circuit.

Additionally or alternatively, the predetermined distance is in the range of 3.5-3.7 mm.

Additionally or alternatively, the flow cell further comprises a step between the flow-through cylindrical electrode and the offset.

Additionally or alternatively, the flow cell further comprises a lip stop.

In another aspect, a method for forming a flow cell for electrophoretic mobility measurements comprises forming first and second flow-through cylindrical electrodes having a dimension that is less than a dimension of an interior of a first luer and a second luer; and inserting the first and second flow-through cylindrical electrodes into the interior of the first luer and the second luer so that a distal end of the first and second flow-through cylindrical electrodes is offset from a distal end of the first and second luer fittings by a predetermined distance.

Additionally or alternatively, the method further comprises forming a step between the flow-through cylindrical electrode and the offset.

Additionally or alternatively, the method further comprises a lip stop.

In another aspect, a flow cell comprises a top structure including a plurality of first fittings located on one side of the top structure; a plurality of second fittings on the opposite side; channels that extend from the first fittings to the second fittings; fand low-through cylindrical electrodes positioned within the channels, where the distal ends of the electrodes are offset from the distal ends of the second fittings by a predetermined distance; The flow cell also includes a bottom structure comprising fitting receptacles configured to engage with the second fittings; f fluid pathway extending from one channel and corresponding second fitting to another channel and its corresponding second fitting.

Additional embodiments may feature a disposable construction, electrical connectors for establishing conductive paths to external circuits; electrode offsets within a defined range (e.g., 3.5-3.7 mm), a structural “step” between the electrode and the offset region, and/or mechanical lip stop to assist with assembly or alignment.

### BRIEF DESCRIPTION OF THE DRAWINGS

FIG. 1 is a block diagram of a particle characterization system in which embodiments of the present inventive concept can be practiced.

FIG. 2 is a schematic diagram of an electrophoretic apparatus, in accordance with some embodiments.

FIG. 3 is a cross-sectional view of a connection region between top and bottom portions of the electrophoretic apparatus of FIG. 2.

FIG. 4 is a photograph of a crack in a luer fitting of the electrophoretic apparatus of FIG. 2.

FIG. 5 is a cross-sectional view of a top portion of an electrophoretic apparatus, in accordance with an embodiment of the present inventive concept.

FIG. 6 is a cross-sectional view of a connection region of the electrophoretic apparatus of FIG. 2 having the bottom portion of FIG. 5.

FIG. 7 is a schematic diagram of a measurement system performing an insertion force test on an electrophoretic apparatus, in accordance with some embodiments.

FIG. 8 is a graph illustrating results of the insertion force test performed by the measurement system of FIG. 7.

FIG. 9 is a schematic diagram of a measurement system performing a separation test on an electrophoretic apparatus, in accordance with some embodiments.

FIG. 10 is a graph illustrating results of the separation test performed by the measurement system of FIG. 9.

FIG. 11 is a flow diagram of a method for forming a luer, in accordance with some embodiments.

FIG. 12 is a cross-sectional view of a connection region of an electrophoretic apparatus, in accordance with an embodiment of the present inventive concept.

FIG. 13 is a cross-sectional view of a connection region of an electrophoretic apparatus, in accordance with an embodiment of the present inventive concept.

FIG. 14 is a front view of the electrophoretic apparatus of FIGS. 12 and 13, in accordance with an embodiment of the present inventive concept.

FIG. 15 is a perspective view of top portion of the electrophoretic apparatus of FIG. 14, in accordance with an embodiment of the present inventive concept.

An Appendix is included herewith.

### DETAILED DESCRIPTION

The present disclosure describes a flow cell for electrophoretic mobility measurement. In an exemplary embodiment, the flow cell comprises a top structure, comprising: two first fittings at a proximal end of the top structure; two second fittings at a distal end of the top structure; a plurality of channels extending from the first fittings to the second fittings; a plurality of flow-through cylindrical electrodes extending through the plurality of channels, wherein a distal end of the flow-through cylindrical electrodes is offset from a distal end of the second fittings by a predetermined distance; and a bottom structure comprising a plurality of fitting receptacles constructed and arranged to connect to the second fittings.

### Definitions

### Particle

A particle may be a constituent of a liquid sample aliquot. Such particles may be molecules of varying types and sizes, nanoparticles, virus like particles, liposomes, emulsions, bacteria, and colloids. These particles may range in size on the order of nanometer to microns.

### Analysis of Macromolecular or Particle Species in Solution

The analysis of macromolecular or particle species in solution may be achieved by preparing a sample in an appropriate solvent and then injecting an aliquot thereof into a separation system such as a liquid chromatography (LC) column or field flow fractionation (FFF) channel where the different species of particles contained within the sample are separated into their various constituencies. Once separated, generally based on size, mass, or column affinity, the samples may be subjected to analysis by means of light scattering, refractive index, ultraviolet absorption, electrophoretic mobility, and viscometrical response.

### Light Scattering

Light scattering (LS) is a non-invasive technique for characterizing macromolecules and a wide range of particles in solution. The two types of light scattering detection frequently used for the characterization of macromolecules are static light scattering and dynamic light scattering.

### Dynamic Light Scattering

Dynamic light scattering is also known as quasi-elastic light scattering (QELS) and photon correlation spectroscopy (PCS). In a DLS experiment, time-dependent fluctuations in the scattered light signal are measured using a fast photodetector. DLS measurements determine the diffusion coefficient of the molecules or particles, which can in turn be used to calculate their hydrodynamic radius.

### Static Light Scattering

Static light scattering (SLS) includes a variety of techniques, such as single angle light scattering (SALS), dual angle light scattering (DALS), low angle light scattering (LALS), and multi-angle light scattering (MALS). SLS experiments generally involve the measurement of the absolute intensity of the light scattered from a sample in solution that is illuminated by a fine beam of light. Such measurement is often used, for appropriate classes of particles/molecules, to determine the size and structure of the sample molecules or particles, and, when combined with knowledge of the sample concentration, the determination of weight average molar mass. In addition, nonlinearity of the intensity of scattered light as a function of sample concentration may be used to measure interparticle interactions and associations.

### Multi-Angle Light Scattering

Multi-angle light scattering (MALS) is a SLS technique for measuring the light scattered by a sample into a plurality of angles. It is used for determining both the absolute molar mass and the average size of molecules in solution, by detecting how they scatter light. Collimated light from a laser source is most often used, in which case the technique can be referred to as multiangle laser light scattering (MALLS). The “multi-angle” term refers to the detection of scattered light at different discrete angles as measured, for example, by a single detector moved over a range that includes the particular angles selected or an array of detectors fixed at specific angular locations.

A MALS measurement requires a set of ancillary elements. Most important among them is a collimated or focused light beam (usually from a laser source producing a collimated beam of monochromatic light) that illuminates a region of the sample. The beam is generally plane-polarized perpendicular to the plane of measurement, though other polarizations may be used especially when studying anisotropic particles. Another required element is an optical cell to hold the sample being measured. Alternatively, cells incorporating means to permit measurement of flowing samples may be employed. If single-particles scattering properties are to be measured, a means to introduce such particles one-at-a-time through the light beam at a point generally equidistant from the surrounding detectors must be provided.

Although most MALS-based measurements are performed in a plane containing a set of detectors usually equidistantly placed from a centrally located sample through which the illuminating beam passes, three-dimensional versions also have been developed where the detectors lie on the surface of a sphere with the sample controlled to pass through its center where it intersects the path of the incident light beam passing along a diameter of the sphere. The MALS technique generally collects multiplexed data sequentially from the outputs of a set of discrete detectors. The MALS light scattering photometer generally has a plurality of detectors.

Normalizing the signals captured by the photodetectors of a MALS detector at each angle may be necessary because different detectors in the MALS detector (i) may have slightly different quantum efficiencies and different gains, and (ii) may look at different geometrical scattering volumes. Without normalizing for these differences, the MALS detector results could be nonsensical and improperly weighted toward different detector angles.

### Electrophoretic Light Scattering

Electrophoretic light scattering (ELS) is a technique used to measure the electrophoretic mobility of particles in dispersion, or molecules in solution. This mobility is often converted to Zeta potential to enable comparison of materials under different experimental conditions. The fundamental physical principle is that of electrophoresis. A dispersion is introduced into a cell containing two electrodes. An electrical field is applied to the electrodes, and particles or molecules that have a net charge, or more strictly a net zeta potential will migrate towards the oppositely charged electrode with a velocity, known as the mobility, which is related to their zeta potential.

When an electric field is applied to a sample, any charged objects in the sample will be influenced by that field. The extra movement that particles exhibit as a result of them experiencing the electric field is called the electrophoretic mobility. Its typical units are μm·cm/V·s (micrometer centimeter per Volt second) since it is a velocity [μm/s] per field strength [V/cm]. The electrophoretic mobility is the direct measurement from which the zeta potential can be derived (using either the Smoluchowski/Debye-Hückel approximations or the complete Henry function F (ka) to get from the mobility to a zeta potential).

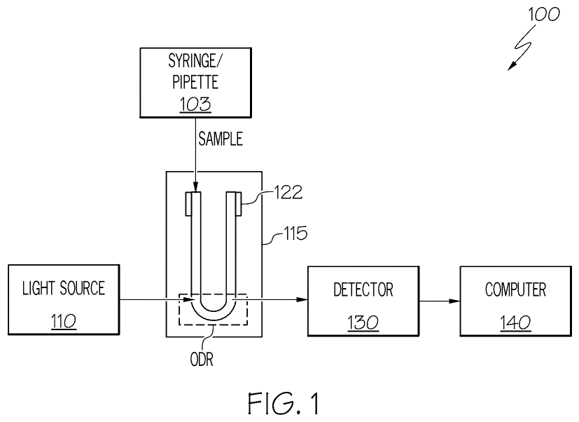

FIG. 1 is a schematic diagram of a particle characterization system 100 in which embodiments of the present inventive concept can be practiced. The particle characterization system 100 can be used to measure particle size distributions of samples and determine size-dependent payload or the encapsulation efficiency of nanoparticle drugs or other samples. For example, the system 100 can combine dynamic, electrophoretic and static light scattering in order to characterize nanoparticle suspensions and macromolecular solutions. The system 100 can be implemented as a tool for delivering size and polydispersity, zeta potential, particle concentration, molar mass, and turbidity/opalescence for molecules of various sizes such as nanoparticles, macromolecules, and so on. Accordingly, the system 100 can be implemented to analyze and quantify viral vectors, vesicles, lipid nanoparticles, inorganic nanoparticles, nano emulsions, polymers, peptides, proteins, and/or nucleic acids, but not limited thereto.

In some embodiments, the particle characterization system 100 includes a light source 110, an electrophoretic apparatus 115, a detector 130, and a computer 140.

The light source 110 is constructed and arranged to emit light across a wide range of wavelengths for laser Doppler electrophoretic measurements or the like. In some embodiments, the light source 102 is a single light source, for example, a light-emitting diode (LED), laser diode, lamp, or other light source.

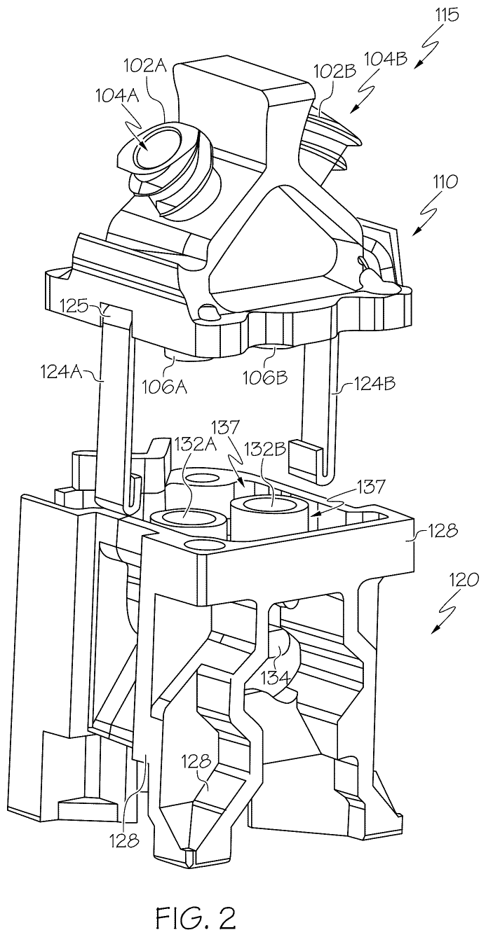

In some embodiments, the particle characterization system 100 applies a light scattering technique to measure the electrophoretic mobility of particles in dispersion, or molecules in solution. This mobility is often converted to a zeta potential to enable a comparison of materials under different experimental conditions. The fundamental physical principle is that of electrophoresis. A dispersion is introduced into the electrophoretic apparatus 115, which may be implemented as a flow cell that is compatible with a light scattering measurement system described in the definitions above, such as the Wyatt Zetastar™ system, which can perform different types of measurements, including but not limited to electrophoretic mobility measurements. As shown in FIG. 2, the electrophoretic apparatus 115 includes at least one input into which a sample is injected by an injection apparatus or system, such as a user-based syringe, pipette, and so on, which injects the sample into an optical detection region (ODR) at the base of the flow cell 115. The second channel will be plugged after the user injects a sample into the first channel.

During operation, an electrical field is applied to the electrodes 112, and particles or molecules that have a net charge, or more strictly a net zeta potential will migrate towards their respective counter electrodes, or oppositely charged electrode with a velocity, known as the mobility, which is related to their zeta potential. The particles or molecules in suspension at the ODR are illuminated by the source of light. When an electric field is applied to a sample, any charged objects in the sample will be influenced by that field. The extra movement that particles exhibit as a result of them experiencing the electric field is called the electrophoretic mobility. Its typical units are μm·cm/V's (micrometer centimeter per Volt second) since it is a velocity [μm/s] per field strength [V/cm]. The electrophoretic mobility is the direct measurement from which the zeta potential can be derived (using either the Smoluchowski/Debye-Hückel approximations or the complete Henry function F(κa) to get from the mobility to a zeta potential).

The detector 130 may be at an output end of the flow cell 115 for converting the received light from the flow cell 115 into an electronic signal readable by the computer 140. The detector 130 may include one or more transmission photodiodes, semiconductors, or the like for measuring the light intensity, scattering component, and/or other emission spectra of the source of light transmitted by the light source 110.

FIG. 2 is a schematic diagram of the electrophoretic apparatus 115 of FIG. 1, in accordance with some embodiments.

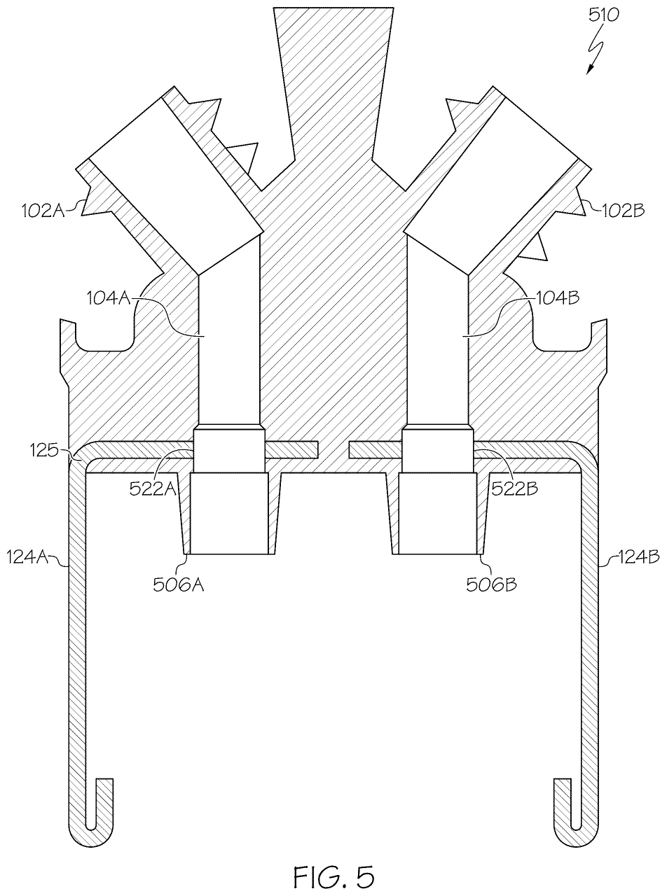

In an embodiment, the apparatus 115 includes a top structure 110, also referred to as a top portion, including a first set of fittings 102A, 102B (generally, 102), and set of channels 104A, 104B (generally, 104) extending through the first set of fittings 102A, 102B, respectively. In some embodiments, the first fittings 102 may include two luer fittings 102A, 102B (not limited thereto) for fluid introduction. In some embodiments, flow-through cylindrical electrodes 122A, 122B (generally, 122)—shown in FIG. 5 extend through the channels 104A, 104B, respectively. The top structure 110 further includes electrical connectors 124A, 124B (generally) conductively connected to the electrodes 122A, 122B, respectively, to connect to at least one external circuit (not shown).

The top structure 110 further comprises second set of fittings 106A, 106B (generally, 106) at the bottom to the channels 104A, 104B, respectively, serving as outlets and for attaching to external fluid connectors. In some embodiments, the second fittings 106 are luer fittings.

The electrophoretic apparatus 115, or flow cell, also comprises a bottom structure 120 including a set of fitting receptacles 132A, 132B (generally, 132) to connect to the second set of fittings 106A, 106B, respectively, of the top structure 110. In some embodiments, the fitting receptacles 132 are luer fitting receptacles.

The bottom structure 120 also includes one or more optical windows 134 to transmit in light from a light source and to transmit out scattered light from a sample for detection and analysis and indexing surfaces 128 to index on an external instrument electrophoretic mobility measurement instrument (not shown). In an embodiment, the second fittings 106 include luer locks. In an embodiment, the bottom structure 120 further includes at least one leak channel 137, to divert leaked fluid to waste. The fitting receptacles 132 may be positioned in the leak channel 137.

In an embodiment, the electrodes 122 of the top structure 110 include a metal selected from the group consisting of a noble metal and corrosion resistant stainless steel. For example, the noble metal could be platinum, palladium, gold flashed beryllium. In an embodiment, the electrical connectors 124 include press-fitting tabs 125 to allow for the insertion of the electrodes 124 into the top structure 121, or more specifically, regions of the top structure 120 having grooves, cutouts, holes or the like for receiving and holding in place the electrodes 124 coupled to the electrodes 122 at a bottom region of the channels 104. The press-fitting tabs 125 may allow for the insertion of the electrodes 124 through the body of the top structure 120 with a minimum amount of force while ensuring good mechanical and electrical contact between the electrodes 122 and the electrical connectors 124. When inserted into an instrument (not shown), the electrical connectors 124 can make a physical contact with an external circuit of the instrument such as the battery contact receptacles in the instrument.

In an embodiment wherein the electrophoretic apparatus 115 is a flow cell, a total channel length of the flow cell 115 and a cross-sectional area of the flow cell 115 are chosen to minimize convection, joule heating, and sample volume. For example, the areas are chosen based on ergonomic design-fit in a read head of the instrument, such that if the areas are too small, then the flow cell 115 could not fit in the read head of the electrophoretic mobility measurement instrument that physically receives and interfaces with the flow cell 115 because the flow cell 115 would not be able to be manipulated with a user's fingers. In an embodiment, the ratio of the height of the flow cell 115 to the channel length of the flow cell 115 is about 1:5, as dictated by a u-shaped channel in the bottom structure 120. In an embodiment, the optical windows 134 are recessed into the bottom structure 120 to prevent the windows 134 from being mistakenly touched.

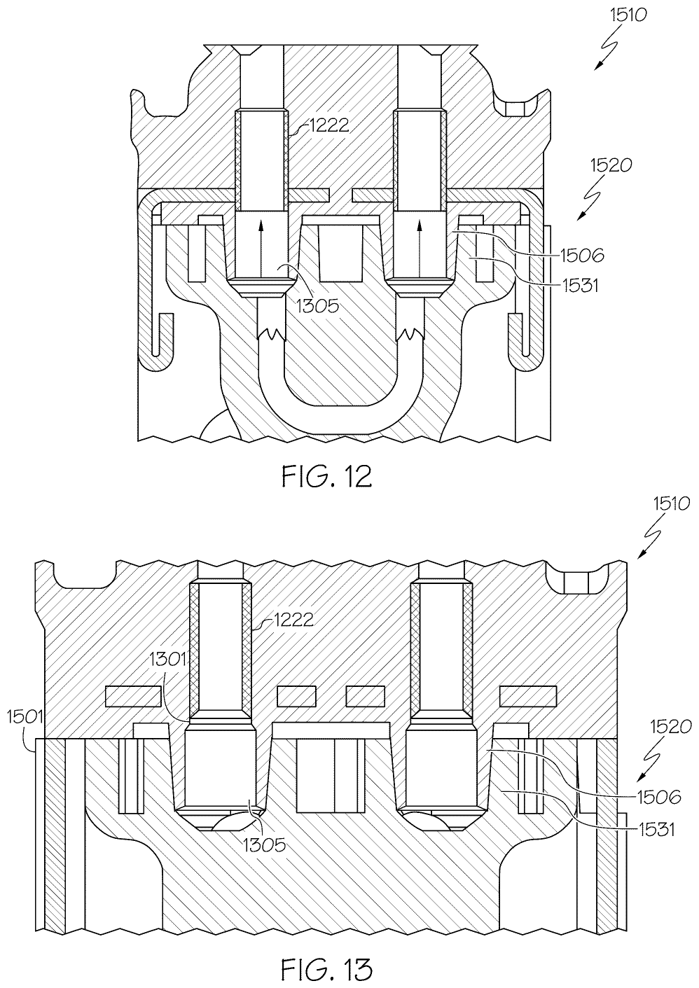

In an embodiment, the flow-through cylindrical electrodes 122 allow a source of sample fluid to flow through them, since the electrodes 122 extend through the bottom luers 106 to the u-shaped channel in the bottom structure 120. An example of a u-shaped channel is shown in FIG. 12. In an embodiment, the electrical connectors 124 are Be, Cu, or Au plated Cu—Be alloy. In an embodiment, the top 110 and/or bottom structure 120 is formed at least on in part of a pure optical molding.

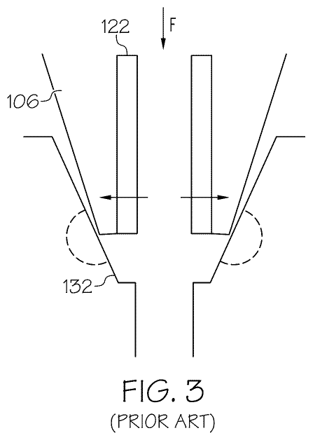

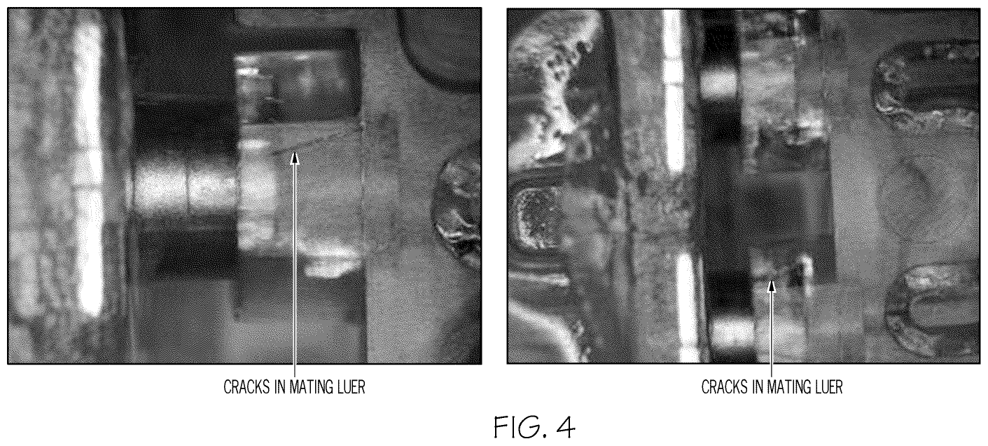

The presence of a flow-through cylindrical electrode 122 such as a central electrode tube at each male fitting 106 in the top portion 120 of the electrophoretic apparatus 115 adds significance stiffness to the luer and may prevent the luer from properly conforming to the mating receptacle 132 of the bottom portion 120, which as shown in FIGS. 3 and 4 can result in cracks formed in the mating luer receptacles 132 that mates with the second luers 106 of the top structure 120 through which the electrodes 122 extend. The electrodes 122 extending through most or all of the entire luer 106 can take away from the compliance of the luer, which is generally formed of compliant materials such as cyclic olefin copolymer (CoC), resulting from the stress concentrations from line contacts formed by the mating luers 106, 132 of the top and bottom structures 110, 120, respectively. The “feel” during assembly that includes a mating of the luers 106, 132 is inadequate so an excessive force may be applied when one luer 106 is inserted into another leur 132, which can cause the cracking. With the lack of ‘feel,’ the user is also unable to tell when the two parts 110, 120 are properly mated.

In brief overview, embodiments of the present inventive concept include an electrophoretic apparatus that reduces the risk of crack formation by moving the tubular electrodes away from top luer and thereby forming a region of separation between the electrodes and the end of the top luer abutting the bottom luer (see for example FIG. 6) and in doing so freeing up the luer so that the feel is better when coupling the luers together.

FIG. 5 is a cross-sectional view of a top portion 520 of an electrophoretic apparatus, such as the flow cell 115 of FIGS. 1 and 2, in accordance with an embodiment of the present inventive concept.

In some embodiments, a central electrode 522 having a tubular construction extends through at least a portion of the length of each of the second luers 506A, 506B (generally, 506). The second luers 506 may be similar to or the same as the luers 106 of FIGS. 1-5 except for differences in the construction and arrangement of the electrodes 522. As described above and shown in FIGS. 3 and 4, the presence of an electrode extending through the length of the luer to the distal end of the luer this adds significance stiffness and may prevent the luer from properly conforming to the mating receptacle of the bottom portion, which can result in cracks or other imperfections. However, in an embodiment shown in FIGS. 5 and 6, there is no presence of an electrode at the interface between the luers 506 and 132. Instead, a portion of the central electrode 522 extending through the luer 506 is shifted up then removed, which allows the luer 506 to properly conform to the mating receptacle and form a surface contact with the female luer 132 of the bottom structure 120, which prevents cracking, while improving sealing and overall stiffness in the joint. In other words, each electrode 522 may terminate at a distance offset from the distal end of its associated second fitting 506, creating a defined separation. Accordingly, in some embodiments, the top portion 110 of the electrophoretic apparatus of FIG. 2 can be constructed and arranged to have the reduced size central electrode 522 of FIGS. 5 and 6 instead of a full-length electrode 122 extending to the distal end of the luer. Therefore, the distal end of each flow-through electrode 522 is recessed inside its fitting by a predetermined distance, typically between 3.5-3.7 mm. This shift minimizes luer stiffness, improving compliance and sealing integrity during coupling. Also, by moving the electrode upward (away from the distal fitting), and optionally incorporating a step in the fitting wall (described below), stress is redistributed to reduce cracking during assembly.

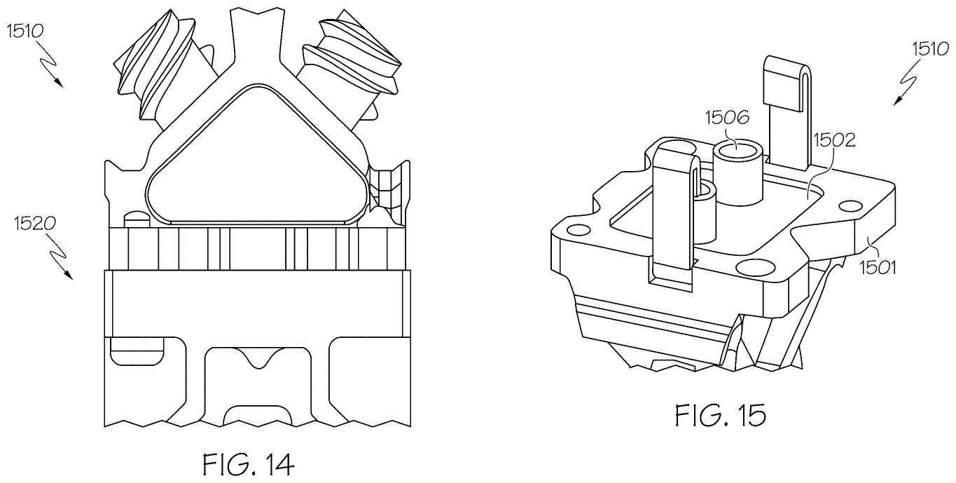

In other embodiments, as described below, since there is a longer and more predictable depth of engagement of the second luer 506 of the top structure 510, a lip stop can be incorporated, for example, lip stop 1501 (see FIGS. 13-15). The lip stop 1501 may be a molded lip stop included at the interface between the top and bottom portions. The lip stop 1501 permits the top portion 1510 to “bottom out” on the bottom portion 1520, which may coincide where the luer of the top portion bottoms out in the well in the bottom portion. In doing so, the outer perimeter of the top portion 1510 is extended to form the stop 1501. The entire surface cannot be extended because it would impact the luer construction. This configuration including a lip can provide tactile and visual feedback to indicate complete engagement and ensures consistent assembly depth, which contributes to better repeatability in measurement.

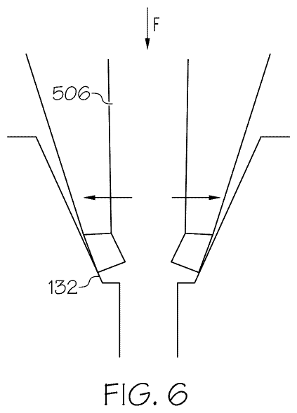

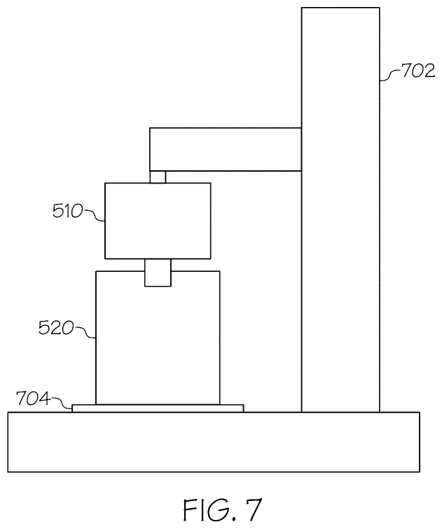

FIGS. 7-10 illustrate experiments performed to gather measurements taken of the electrophoretic apparatus 115 of FIGS. 2 and 5. In particular, the central electrode 522 shown in FIG. 5 is formed to have a reduced length end mill; in this example, a 3.5 end mill. At least a portion is loosely placed into the bottom portion 520, which may be similar to or the same as the bottom portion 120 of FIG. 2.

During the experiment, an insertion force test is performed where a force is applied incrementally in steps of 5N (measured with a force gauge). The purpose for the test is to measure how the luer with shortened electrode and added compliance affects the insertion behavior compared to the baseline design, and to verify whether the luer can bottom out in the mating well without causing damage. The test setup includes the top portion 510 of the flow cell 115 inserted into the bottom portion 520. A force is applied incrementally (e.g., 5N steps) using a force gauge (not shown). After each force increment, the applied force is removed and then a height gauge 702 is lowered until the flexible force sensor 704 detects contact measure an applied force or pressure. This is recorded as a new insertion depth.

As shown in FIGS. 6 and 8, the modified luer, i.e., with the milled central electrode (e.g., 522) engages deeper in the mating well of the female luer (e.g., 132) and exhibits a force slope increase only when the luer hits the bottom of the well. S1 and S2 are samples that were modified for testing purposes. Here, no cracking was observed. The “knee” in the force curve in FIG. 8 corresponds to the luer 522 reaching the bottom of the well in the female luer of the bottom portion 520. On the other hand, the conventional baseline design (see FIG. 3) has less engagement and exhibits sharp increase in force well before reaching the stop 1501, due possibly to cracking occurring at the bottom portion 520.

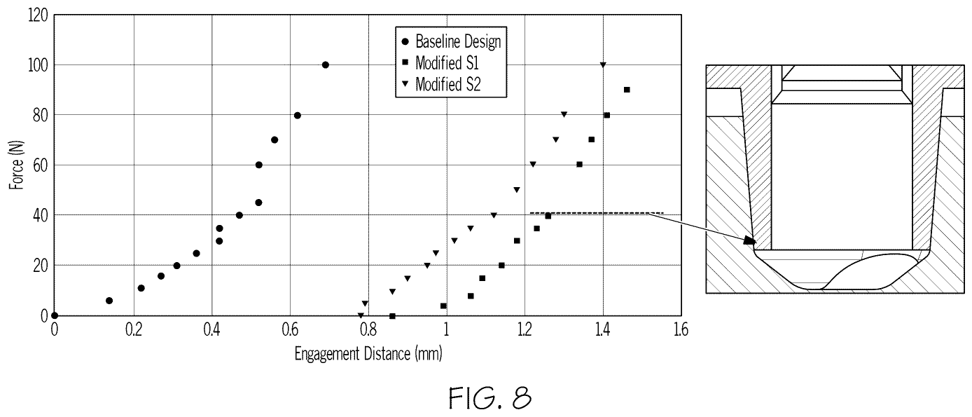

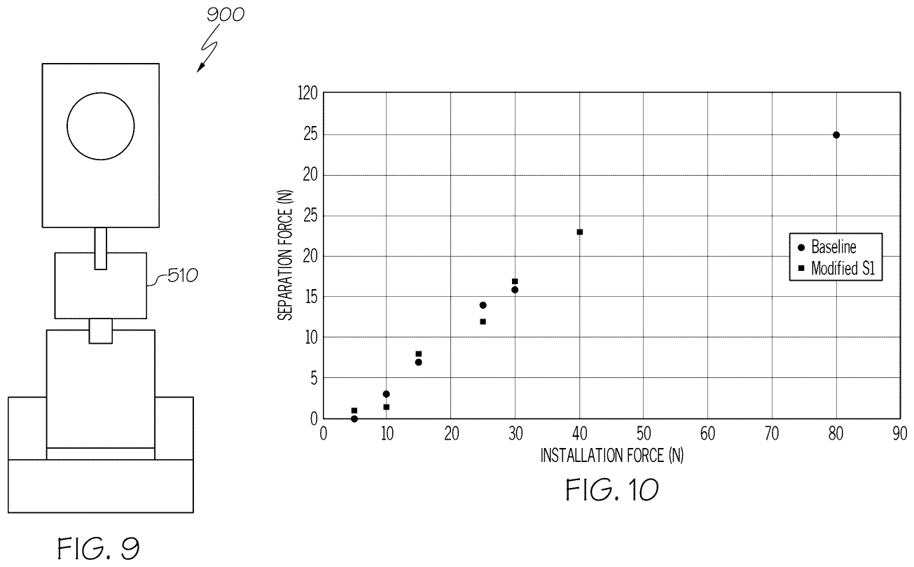

As shown in FIGS. 9 and 10, a test setup 900 performs a separation test to measure the peak force required (y axis) to pull the top portion 510 from the bottom portion 520 when pressed together with force (shown along the x axis). As shown in the graph, both profiles are nearly identical. Therefore, increasing compliance does not compromise the mechanical integrity of the joint.

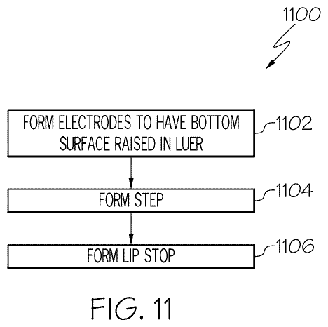

FIG. 11 is a flow diagram of a method 1100 for forming a luer 1506, in accordance with some embodiments. FIGS. 12-15 are views of the luer 1506 formed by the method 1100. The formed luer 1506 may be similar to or the same as a second fitting 506, e.g., a luer fitting, shown and described in FIG. 5 and can be used in the experimental data shown in FIGS. 7-10.

In some embodiments, the electrodes 1222 in FIGS. 12-15, similar to the central electrodes 522 shown and described with respect to FIG. 5, are constructed to be milled or otherwise reduced in length. In step 1102 of the method 1100, the electrodes 1222 are “moved up” inside the luers 1506 so that there is a space or gap between the surface of the electrodes 1506 and the female fitting receptacles 1531 of the bottom portion 1520. In some embodiments, the electrodes 1222 are moved up by a predetermined amount.

At step 1104, a step 1301 is added to the luer to increase compliance, shown in FIG. 13. A thinner luer means increased compliance. When the electrode is moved up, the remainder of the luer can then be further thinned to increase compliance and that's what shows up as a step separating the top from the bottom region which has increased inner diameter (ID). The step 1301 increases a region of separation between the electrode 1222 and the distal end 1305 of the flow-through cylindrical electrodes 1122 due to the reduced length of the electrode 1222 resulting in an offset, or space 1305 inside the second fitting 1506. A distal end of each flow-through cylindrical electrode 1122 is offset from a distal end of the each of the corresponding second fitting 1506 by a predetermined distance. Here, the offset may include a portion of the channel of the u-shaped channel. In some embodiments, the electrode 1222 may be above or at the step 1301 and the offset 1305, i.e., region of the channel that is absent any portion of the electrode 1222, may be at or below the step 1301, for example, shown in FIG. 13. In some embodiments, the luer 1506 can be thickened by modifying the core pin used to define the ID of the fitting 1506, which can allow for a safe formation of the step 1301. In some embodiments, the step 1301 can have a thickness of 3.5 mm, but not limited thereto. The safe formation can occur by forming injection molds by milling out steel blocks. Removing metal means more plastic ends up in the final object, and even though it's very easy to remove metal, it's almost impossible to put it back in. It is therefore preferable to mill a smaller amount of metal out of the mold and add less plastic. If a change is desired, additional plastic can be added into the final part by removing metal, referred to as a “tool-safe mold change.”

With regard to the core pins, they are generally fixed in the plastic mold and used to create a desired shape in the molded or cast part. Unlike the purpose of a an ejector pin which is pushed or extended by the ejector plate to eject the cooled molded or cast part from the cavity/core. Core pins may be used in aluminum molds to create tall, thin cores that might be too fragile if machined out of the bulk aluminum of the mold. In some applications, core pins are used for part ejection from a casting die. In the present case, core pins can be used to create the inner diameter (ID) of the luers.

At step 1106, a lip stop 1501 is formed in the top portion 1510. Unlike conventional devices where electrodes extend through a luer and the final assembled height of the electrophoretic apparatus depends sharply on the installation force (and the non-linear yield/fracture properties of the bottom half), the electrophoretic apparatus in accordance with some embodiments includes a definite stop, which is possible as the luer can bottom out fully in the well with reasonable installation force (˜40N). For a better visual feedback to the user, the lip stop 1501 is added coinciding with where the luer bottoms out in the well. Otherwise, a gap or space may be present between the distal end of the shortened electrode 1222 and the bottom of the fitting 1506 when coupling the luers 1506, 1531 together, which may be unsettling to the user who may be unclear whether the luers are correctly coupled together. For example, this can be enabled by the longer and more predictable depth of engagement mentioned before. In some embodiments, a stop can be added somewhere along the depth without compromising mating robustness.

The following is a summary of features offered by an electrophoretic apparatus in accordance with embodiments of the present inventive concept:

Softer insertion: With increased compliance in the luers, the electrophoretic apparatus assembly of the top portion with the bottom portion feels “softer” to a user coupling the luers of the top and bottom assemblies together so that this software feeling is more akin to that of a syringe luer.

Definite stop: The lip stop 1501 physically contacting a mating surface at the bottom luer 1531 can establish the contact point defining the maximum insertion depth, referred to as a definite hard stop, as shown in FIGS. 13-15. The lip (the region outside the interior moat 1502 of the top portion 1510) gives the user feedback on proper assembly of the two halves, i.e., top portion 1510 and bottom portion 1520. As described above, the stop 1501 can be a thickened ring or flange molded into the outer surface of the top luer. The lip stop 1501 also helps affirm the robustness of the joint in terms of resistance against rocking moments This is because the stop 1501 mates with the surface of the bottom 1520 over wider area and hence offers more resistance to rocking moments.

No damage to bottom half: With increased compliance in the luer, the luer mating features are not damaged during insertion and the seal is not compromised.

Repeatable channel length: With a defined hard stop, the final channel length between the electrodes, which directly affects conductivity measurements, has better repeatability between user assembled cuvettes.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A flow cell comprising:
a top structure, comprising:
a plurality of first fittings at a first side of the top structure;
a plurality of second fittings at a second side of the top structure;
a plurality of channels extending from the first fittings to the second fittings;
a plurality of flow-through cylindrical electrodes extending through the plurality of channels, wherein a distal end of the flow-through cylindrical electrodes is offset from a distal end of the second fittings by a predetermined distance, the flow cell further comprising:
a bottom structure comprising:
a plurality of fitting receptacles constructed and arranged to connect to the second fittings; and
a fluid path that extends from one channel of the plurality of channels and one of the second fittings in communication with the one channel to another channel of the plurality of channels and another of the second fittings in communication with the other channel.

2. The flow cell of claim 1, wherein the flow cell is a disposable flow cell.

3. The flow cell of claim 1, further comprising a plurality of electrical connectors connected to the electrodes for providing a conductive flow path to an external circuit.

4. The flow cell of claim 1, wherein the predetermined distance is in the range of 3.5-3.7 mm.

5. The flow cell of claim 1, further comprising a step between the flow-through cylindrical electrode and the offset.

6. The flow cell of claim 1, further comprising a lip stop.

7. The flow cell of claim 1, wherein the first fittings and second fittings are luer fittings.

8. The flow cell of claim 1, wherein the bottom structure comprises a recessed optical window to prevent accidental contact and maintain optical clarity during operation.

9. The flow cell of claim 1, wherein the fittings are formed of cyclic olefin copolymer (CoC) to provide chemical resistance and optical transparency.

10. The flow cell of claim 1, wherein the top structure includes indexing surfaces configured to align the flow cell with an external measurement instrument.

11. The flow cell of claim 1, wherein the lip stop is configured to provide tactile feedback to a user upon full engagement of the top and bottom structures.

12. The flow cell of claim 1, wherein the flow-through cylindrical electrodes are formed from a noble metal selected from the group consisting of platinum, palladium, and gold-flashed beryllium.

13. A method for forming a flow cell for electrophoretic mobility measurements, comprising:
forming first and second flow-through cylindrical electrodes having a dimension that is less than a dimension of an interior of a first luer and a second luer; and
inserting the first and second flow-through cylindrical electrodes into the interior of the first luer and the second luer so that a distal end of the first and second flow-through cylindrical electrodes is offset from a distal end of the first and second luers fittings by a predetermined distance.

14. The method of claim 13, further comprising:
forming a step between the flow-through cylindrical electrode and the offset.

15. The method of claim 13, further comprising forming a lip stop.

16. The method of claim 15, wherein the step of forming the lip stop includes extending an outer perimeter of the top structure to define a mechanical stop surface.

17. The method of claim 13, further comprising forming a recessed optical window in the bottom structure to protect the optical path during sample analysis.

18. The method of claim 13, wherein the electrodes are inserted using press-fit tabs to ensure mechanical and electrical contact with minimal insertion force.

19. The method of claim 13, further comprising forming a leak channel in the bottom structure to divert excess fluid away from the optical detection region.

20. A flow cell comprising:
a plurality of first fittings at a first side of the top portion of the flow cell;
a plurality of second fittings at a second side of the top portion;
a plurality of channels extending from the first fittings to the second fittings;
a flow-through cylindrical electrode extending through each of the plurality of channels to a second fitting of the plurality of second fittings, wherein a distal end of the flow-through cylindrical electrode is offset from a distal end of the each of the second fittings by a predetermined distance.
